(19) United States
(12) Patent Application Publication
(10) Pub. No.: US 2009/0287655 A1
(43) Pub. Date: Nov. 19, 2009

(54) IMAGE SEARCH ENGINE EMPLOYING USER SUITABILITY FEEDBACK

(76) Inventor: James D. Bennett, Hroznetin (CZ)

Correspondence Address: GARLICK HARRISON & MARKISON, P.O. BOX 160727, AUSTIN, TX, 78716-0727, US

(21) Appl. No.: 12/415,673

(22) Filed: Mar. 31, 2009

Related U.S. Application Data
(63) Continuation-in-part of application No. 12/185,796, filed on Aug. 4, 2008.
Application No. 12/185,796 is a continuation-in-part of application No. 12/185,804, filed on Aug. 4, 2008.
(60) Provisional application No. 61/052,776, filed on May 13, 2008.

(51) Int. Cl. G06F 17/30

(52) U.S. Cl. 707/3; 707/E17.108; 707/E17.019

(57) ABSTRACT

An Internet infrastructure that supports searching of images by correlating a search image and/or search string with that of plurality of images hosted in Internet based servers. The image search server supports delivery of search result pages to a client device based upon a search string or search image, and contains images from a plurality of Internet based web hosting servers. The image search server delivers a search result page containing images upon receiving a search string and/or search image from the web browser. The selection of images in the search result page is based upon: (i) word match, that is, by selecting images, titles of which correspond to the search string; and (ii) image correlation, that is, by selecting images, image characteristics of which correlates to that of search image. The selection of images in the search result page also occurs on the basis of popularity and may be refined by taking into account user feedback/preferences.

### CROSS REFERENCES TO PRIORITY APPLICATIONS

The present application:

(1) is a continuation in part of U.S. Utility application Ser. No. 12/185,796, filed Aug. 4, 2008;

(2) is a continuation in part of U.S. Utility application Ser. No. 12/185,804, filed Aug. 4, 2008; and

(3) claims priority under 35 U.S.C. 119(e) to U.S. Provisional Application Ser. No. 61/052,776, filed May 13, 2008, all of which are incorporated herein by reference in their entirety for all purposes.

### BACKGROUND

1. Technical Field

The present invention relates generally to Internet infrastructures; and, more particularly, to search engines.

2. Related Art

Image search engines provide an easy and efficient way of searching for images over the Internet. These images are obtained during crawling operations, via the search engines, and are stored along with associated web links. The user may typically provide a search string as a search criterion and receives a list of images along with links to their original locations in response to the entry of the search string. The User's interest in searching for images may vary widely, and the wide variety of interests may include business, engineering, and scientific research, as well as home based general interests.

When a user searches images using a typical image search engine, they usually get a bunch of unwanted images that are not relevant to the user. For example, in response to the image search term ‘cow’, the user may receive everything from sex photos, cartoon cows, text images, rodeo pictures, pictures of dairy cows, dairy farm pictures, pictures of dairy products, and anything else anyone happened to associate with ‘cow’ in their path data, metadata, or file name of an image.

The user has no control over what he/she receives as a result of providing a search string such as ‘cow’, and the user will often not know exactly how to modify the original search string to narrow down the search results to obtain a desired set of search result images. The user has no control over improving the search results because it requires a great deal of inside knowledge about how a search engine operates, the structure of complex data structures, and/or the specific data the search database contains. Often this trial and error process of narrowing down the search results ends up wasting a lot of user's time, and may even completely frustrate the image search altogether. In addition, most search engines do not allow users to participate in the image search process to improve overall performance of the image search engines.

The image search results are typically displayed in few rows by few columns (a matrix on a display screen), with a ‘next’ button leading to the next image search result page and a ‘previous’ button leading to a previous image search result page. If a user does not find what he/she is looking for in the first few image search result pages, subsequent pages are unlikely to yield useful results, and there may be hundreds of pages or more waiting to be viewed.

These and other limitations and deficiencies associated with the related art may be more fully appreciated by those skilled in the art after comparing such related art with various aspects of the present invention as set forth herein with reference to the figures.

### BRIEF SUMMARY OF THE INVENTION

The present invention(s) and specific embodiments taught herein are directed to an apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a schematic block diagram illustrating an Internet infrastructure containing a client device and a web-browser-accessible image search server, wherein the image search server allows quick feedback of suitability associated with one or more images for a given search criteria and/or a given search category;

FIG. 2 is a schematic block diagram illustrating components of the image search server constructed in accordance with the embodiment of FIG. 1;

FIG. 3 is an exemplary schematic block diagram illustrating a snap shot of an image search result page containing suitability feedback checkboxes;

FIG. 4 is an exemplary schematic block diagram illustrating a snap shot of an image search result page containing suitability feedback via a popup window;

FIG. 5 is a flow diagram illustrating functionality of the image search server of FIG. 1 during gathering and storing operations performed using image suitability feedback information;

FIGS. 6-7 are flow diagrams showing, in more detail, the functionality of the suitability feedback support module of FIG. 1 in conjunction with the image search server; and

FIG. 8 is a flow diagram illustrating the functionality of the image search server of FIG. 1 during execution of a search operation.

### DETAILED DESCRIPTION OF THE DRAWINGS

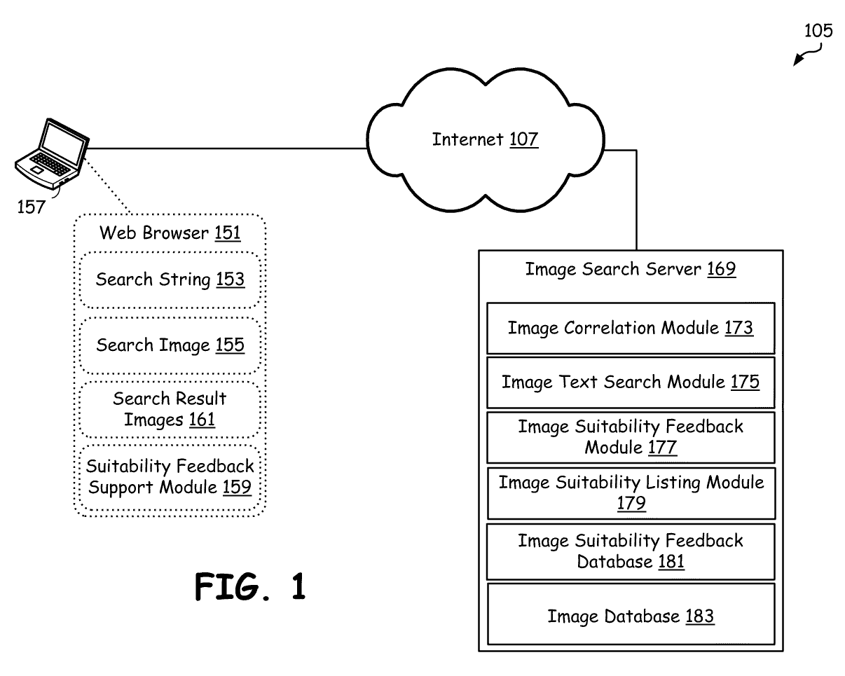

FIG. 1 is a schematic block diagram illustrating an Internet infrastructure 105 containing one or more client device(s) 157 and a web-browser-accessible image search server 169. The image search server 169 can initiate, accept, and/or process quick feedback related to the suitability of an image for a given search criteria and/or given search category. In specific, the image search server 169 provides or enables the display of feedback checkboxes along with each of the images 161 delivered to or accessible by the client device 157 in search result pages. These checkboxes allow one or more users to quickly mark images 161 in a manual or machine-automated review process as being related, relevant, or desirable to a requested search string or process. In addition, these feedback checkboxes allow users to mark a delivered image 161 as unsuitable for various categories, purposes, or searches. This image suitability feedback information obtained, through the feedback checkboxes, voice recognition, user input, user interaction or conduct with the search items, or other methods, help the search engine server 169 to better identify and provide search results for current search requests and possibly future search requests.

The image search server 169 delivers images 161 or image results, pointers, addresses, locations, data, or results 161 to the client device 157 based upon search criteria that may include a search string 153 and/or an exemplary search image 155. In the search result page, along with images 161 in the search result page, the image search server 169 provides one or more text messages/windows such as ‘Unsuitable For:’ along with checkboxes that allows a user to quickly provide feedback that the image 161 is unsuitable, in certain manners, for this search. Also, the checkboxes may be expanded to include a few categories that allow the image 161 to be marked or identified as unsuitable for specific audiences, purposes, or destinations, such as minors, copyright-protected content, cartoons, and panoramas. In another embodiment, a click on an ‘Unsuitable For:’ link may open a popup window providing the user options such as (unsuitable for:) ‘this search’, ‘minors’, ‘cartoons’, ‘text images’, ‘panoramas’, etc. Further, other manners of collecting user feedback/query data may be used, like allowing a user to drag and drop certain pictures into certain folders or boxes on the computer that indicate that pictures association with on of the “unsuitable for” categories. For example, if picture #1 is unsuitable for children, the user could drag and drop that picture into the file folder, box, or icon titled “Unsuitable for Children” on the client device display screen. Also, other feedback methods, like voice recognition, touch screen interaction, or like method of collecting and applying user feedback may be used.

The feedback obtained from the user may be immediately or subsequently sent to the image search server 169 via web browser 151 or other software and/or hardware in the client device 157. Alternatively, a suitability feedback support module 159 incorporated into the web browser 151 can gather the image suitability feedback information for a given search string 153 and search image 155 and temporarily or permanently store this information in the client device 157. The temporarily stored image suitability feedback information is sent to the image search server 169 periodically or on some specific or predetermined cadence.

Once suitability feedback information or statistics/data associated therewith are stored in the image search server 169, the image suitability feedback information and/or related data/statistics are utilized in the delivery of one or more search results images 161 in the future. In the future search operations, the image search server 169 retrieves the image suitability feedback information, sorts and filters images 161 that are, for example, not suited for minors and given search criteria. For example, if many users or 10 sequential users determine that a certain picture, video, audio, or like multi-media content is excellent for use in schools to help teach how the human nervous system works, then this picture can be flagged with data indicating that this picture is deemed very suitable and relevant for that use or search criteria/terms, whereby subsequent searches by this or other users may make use of that information to improve their later search results.

Image suitability feedback module 177 gathers image suitability feedback information from a plurality of client devices 157, processes the information, and stores the processed image suitability feedback information in an image suitability feedback database 181 for future use. In a typical search operation, the image search server 169 identifies characteristic parameters of the search image 155 received from the client device's web browser 151, if an exemplary search image 155 is used in lieu of or in addition to a text string or search string 153. Then, the image search server 169 correlates these characteristic parameters with that of a plurality of images in an image database 183. Note that the database 183 may be immense, and may span many different servers, computers, and devices across the Internet or other networks, and may take on one or more different forms. Sometimes pointers, metadata, addresses, etc., can be stored pointing elsewhere for the content, or the content itself may be contained in the database, as an original or cached/copied image/media. The image search server 169 then selects and prioritizes images based upon closeness in correlation to that of the search image 155 and on popularity basis, “closeness to the user's desires” indications, date/age, geographic location, source, language, size, complexity, combinations of the foregoing, or other one or more criteria. The image search server 169 also matches words in the search string 153 (if provided in lieu of a search image 155 or in addition to a search image 155) with that of titles, textual metadata, address links, url/html/xml code text, surrounding textual context related to the picture, and other text sources associated with the plurality of images in the image database 183, and then the server 169 can use this data from text comparisons and processing to select a plurality of images that likely correlate to the user's desires.

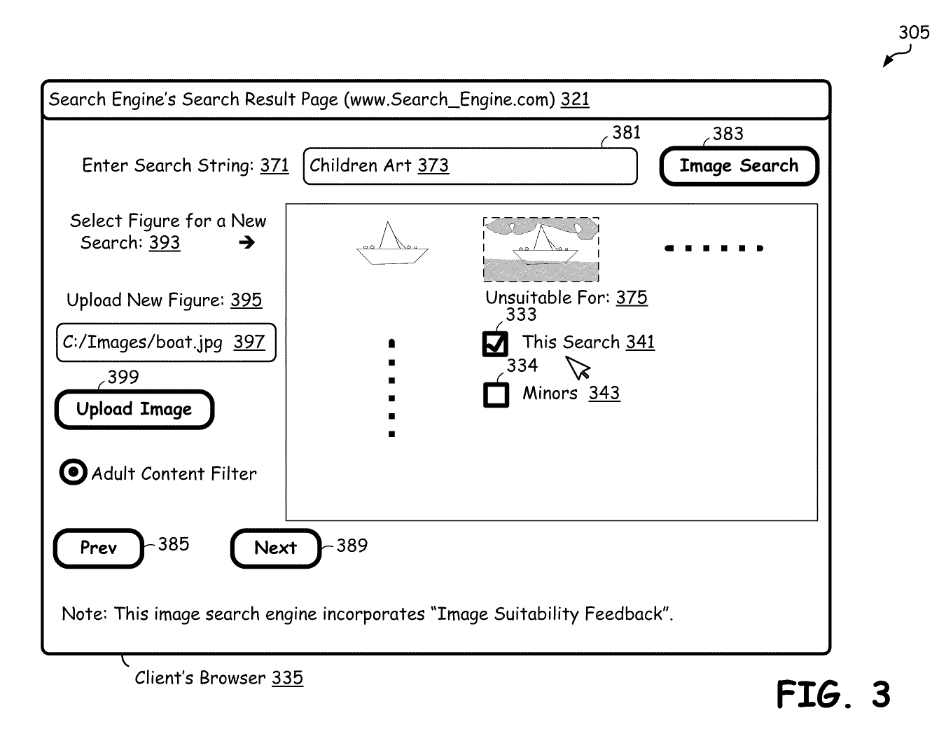

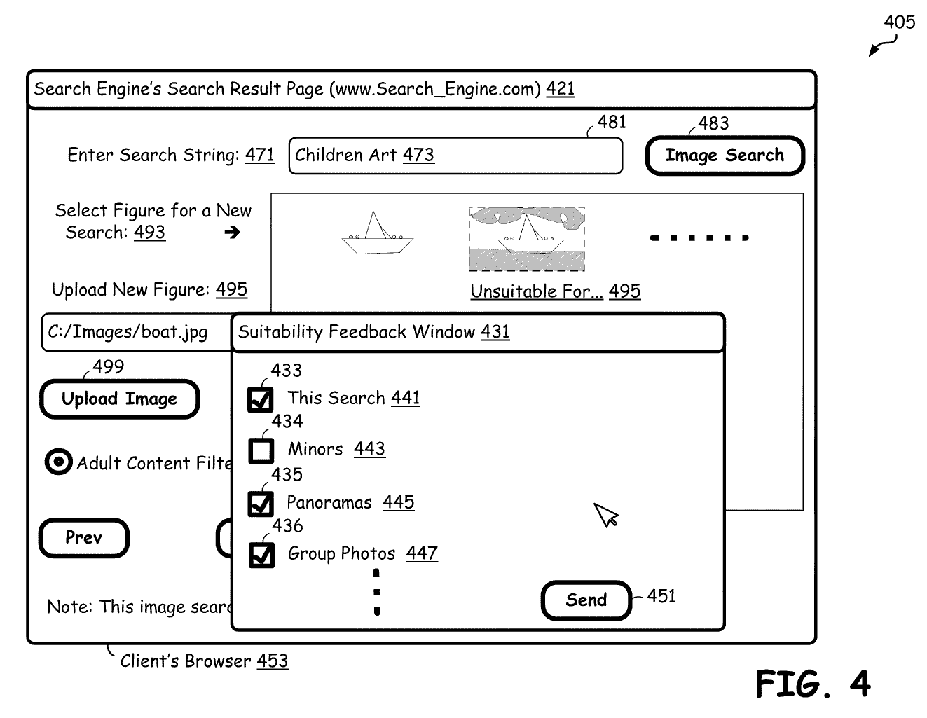

In addition, the image search server 169 may be set to filter for adult content based upon user settings in the client device's 157, a control panel, an application program, or the web browser 151. These selected and filtered images are sorted on the basis of correlation/popularity or some other criteria, as previously mentioned. The image search server 169 retrieves the image suitability feedback information and filters images that are not suited for a given search criteria and/or for a given category. Image suitability listing module 179 sorts images based upon the image suitability feedback information that is stored and sometimes updated in the image suitability feedback information associated with module 177 and/or module 159. Then, the image search server 169 delivers a first few of the images (or pointers to the images) selected on the basis of correlation with the characteristic parameters of the search image 155 and first few of the images selected on the basis of match with the search string 153 (if both a text string and search image are used in the search), in a first search result page. Note, the merging of text-based search results by module 175 and image-based search results by module 173 to present one list of rank-ordered, relevant, or popular search images can be selected via mathematical algorithms, popularity processing, correlation closeness (estimated relevance to user), or other algorithms and does not simply need to be an arbitrary fractional inclusion of images from both sources. The images in the image database 181 are obtained from a plurality of web hosting servers by crawling through them and/or by submissions from one or more users of the Internet (a pier-to-pier embodiment of sharing images is possible to derive image data for database 183). Detailed description of the image search result page is provided with reference to the description of web page snap shots in FIGS. 3 and 4 herein.

The image search server 169 contains an image correlation module 173 that correlates between characteristic parameters of search image 155 and that of the plurality of images in the image database 183. The correlated images in the image database 183 are given a unique image quotient number that represents a closeness to the search image 155 (and/or to a search string 153 in other embodiments). These image quotient numbers are tabled along with other image related aspects such as image titles and web links, and where they were originally located. Then, the table is likely sorted on the basis of closeness of the images in the image database 183 to the user search. In addition, in another table, the first few images (above a threshold image quotient number, for example) that closely correlate with the search image 155 are again sorted on the basis of popularity. This multiple, hierarchical or tiered sorting may be performed to ensure that the images with the most estimated relevance to the user are presented to the user as early in the image search result display process as possible.

An image text search module 175 uses word matching techniques to match words in the search string 153 and that of titles of the plurality of images in the image database 183. The matched images in the image database 183 are given a unique text quotient number that represents the how closely the words of the search string 153 and the words of the titles of the images in the image database 183 match. These text quotient numbers are tabled or database stored along with image titles and web links where images and data are originally located. Then, the table is sorted on the basis of closeness in match and/or other search criteria. In addition, in another table the first few images (above a threshold text quotient number, for example) that closely match are again sorted on the basis of popularity to ensure that the search results most likely to be of interest to the user are presented to the user as early as possible in the search process.

For example, a user may provide a search string 153 as ‘cow’, and may or may not provide a search image of a cow, a cow cartoon, etc., as well. Then, the user may provide the category as ‘panorama’. The user may then expect to get panorama images of cows that correlate highly with one or both of the text search string “cow” and the image provided (if provided). The search engine server provides search results in the form of images 161 in an array or matrix per screen displayed, e.g., 4 rows by 2 columns or 8 rows by 8 columns. The images 161 also come with suitability feedback checkboxes such as ‘Unsuitable For: minors, cartoons, and panoramas’. In another embodiment, a click on an ‘Unsuitable For:’ link may open a popup window providing the user options such as (unsuitable for:) ‘this search’, ‘minors’, ‘cartoons’, ‘text images’, ‘panoramas’, etc. The user is able to quickly mark an image 161 as unsuitable for panoramas, and possibly as unsuitable for this search (implying that the image is unsuitable for a search string that contains ‘cow’ or any search string that is a derivative, synonym, or enhancement of that term).

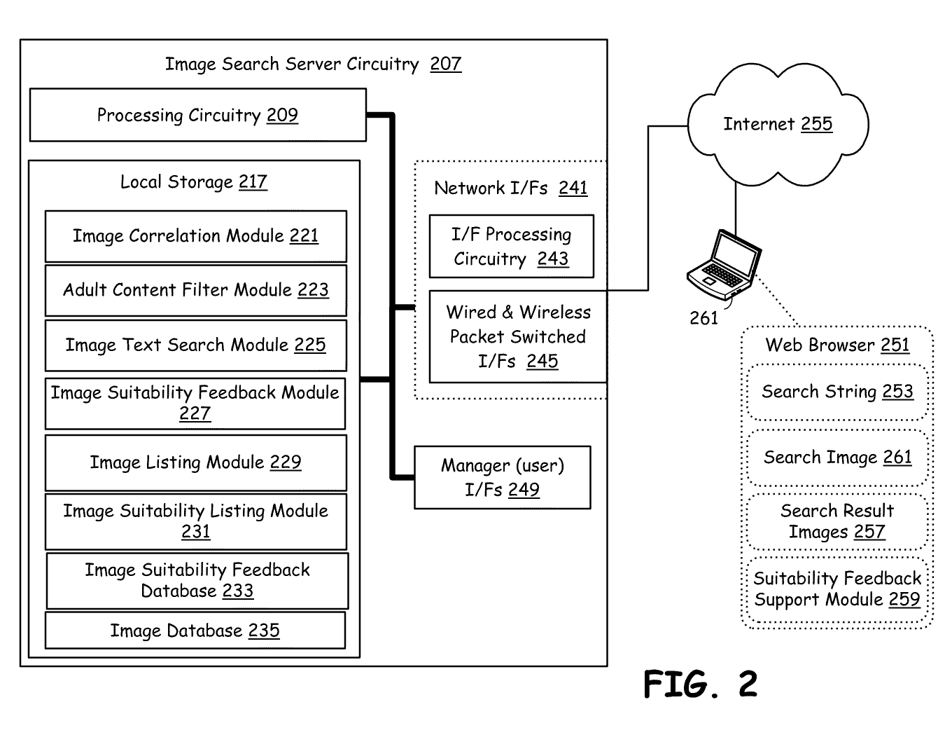

FIG. 2 is a schematic block diagram illustrating the components of the image search server constructed in accordance with the embodiment of FIG. 1. The image search server circuitry 207 may in part or in full be incorporated into any computing device that is capable of serving as an Internet based server, and each element thereof may contain software, hardware, or some combination thereof. The image search server circuitry 207 generally includes processing circuitry 209, local storage 217, manager interfaces 249, and network interfaces 241. While not specifically shown in FIGS. 1-2, the client devices 157 and 261 also contain input and output network communication interface circuitry similar to that shown for server 207 of FIG. 2. These components are communicatively coupled to one another via one or more of a system bus, address/data/control busses, dedicated communication pathways, or other direct or indirect communication pathways. The processing circuitry 209 may be, in various embodiments, a microprocessor or central processing unit (CPU), a digital signal processor, a graphics processor, a state machine, an application specific integrated circuit (ASIC), a field programming gate array (FPGA), combinations thereof, or other processing circuitry/software.

Local storage 217 may be random access memory (dynamic, static, or other), read-only memory (ROM), flash memory, optical memory, ferroelectric storage, nonvolatile memory, electrically erasable memory, a disk drive, an optical drive, magnetic memory, combinations thereof, or another type of memory that is operable to store computer instructions and data. The local storage 217 includes an image correlation module 221, adult content filter module 223, image text search module 225, image suitability feedback module 227, image listing module 229, image suitability listing module 231, image suitability feedback database 233 and image database 235 to facilitate user's image search, and any of these modules may be hardware, software, firmware, or some combination thereof.

The network interfaces 241 contain wired and/or wireless packet-switched interfaces 245 and may also contain built-in or an independent interface processing circuitry/CPU 243. Other network interface circuitry is available for use in FIG. 2. The network interfaces 241 allow the image search server 207 to communicate with client devices such as client 261 in FIG. 2 and to deliver search result pages of images 257 to users and computers. The manager interfaces 249 may include a display and keypad interfaces or other forms of interface mechanisms. These manager interfaces 249 allow the user or IT professional at the image search server 207 to control aspects of the system. The client device 261 that is illustrated is communicatively coupled to the image search server 207 via an Internet 255 or another network or communication connection.

The image suitability feedback module 227 gathers image suitability feedback information continuously from the user or client machines, or from databases that store this information for this user, this search, other users, or other searches. The module 227 then processes this information, and then stores it in the image suitability feedback database 233. In a typical search operation, the image correlation module 221 performs correlation processing between characteristic parameters of the search image (if any) that a web browser 251 of the client device 261 sends to the server 207 and that of the plurality of images in the image database 235. In addition, the image correlation module 221 assigns the correlated images in the image database 235 a unique image quotient number that represents the closeness of each database image to the search image, and tables the image quotient numbers along with other image related aspects such as image titles, metadata, and/or web links. Then, the image correlation module 221 sorts the table on the basis of image quotient numbers or based on some other prioritization scheme, and the image correlation organization may be multi-dimensional, like first sorted on image quotient numbers and then secondarily processed by popularity, age, geography, or other dimensions. These sorted images are then filtered by the adult content filter module 223, by using digital image correlation or known adult tags and notices that are resident on the Internet and sometimes associated with certain content either in the content and web pages themselves or in separate application program databases that are designed to find, log, update, and filter adult content sources/material. Similarly, the image text search module 225 matches words in the search string (if one is provided) and that of titles, applicable text, metadata, etc., of the plurality of images in the image database 235. Then, the image text search module 225 assigns the images in the image database 235 a unique text quotient number that represents the closeness of the match of the subject text to the text search string, along with other image related aspects such as image titles, metadata, size figures, web links, etc. Then, the image text search module 225 sorts the table on the basis of text quotient number, and possibly other factors or multi-dimensional considerations as already taught herein. These sorted images are filtered by the adult content filter module 223, by using word-matching techniques or other techniques as taught herein. Based upon the sorting of images and the filtering, four basic tables are formed in memory/storage.

The image suitability listing module 231, for the given search string 253 and/or search image 261, filters and again sorts images in the four (or a different amount of) basic tables based upon image suitability feedback information in the image suitability feedback database 233. While FIG. 2 shows that the search image 261 and search string 253 are resident on the same client that receives the search results, it is possible for a search string or image to be provided by another client or server and search results delivered to yet another destination. Finally, the image-listing module 229 lists the images from the four basic tables to form a plurality of search result pages, each containing a certain portion of each of the four basic tables in one embodiment (of mixtures of selections from the tables and other numbers of tables are possible), in a mutually exclusive manner so that none of the images in any of the search result pages are repeated for redundant presentation to the user.

In other embodiments, the image search server 207 of FIG. 2 may include fewer or more components than are illustrated as well as lesser or further functionality and different segregation and combination of blocks and features than that shown in FIG. 2. In other words, the illustrated image search server is meant to merely offer one example of possible functionality and construction in accordance with the teachings herein.

FIG. 3 is an exemplary schematic block diagram illustrating a snap shot of an image search result page/display screen containing suitability feedback checkboxes. Specifically, the exemplary snap shot illustrated shows an image search result page 305 delivered to web browser 335 of a client device, containing selected searched images, on the basis of a search string and/or search image correlation. The image search result page that is delivered may contain a page title ‘Search Engine's Search Result Page (www.Search_Engine.com)’ 321. A text such as ‘Enter Search String:’ 371 and text box 381 are provided to facilitate user's further searching and refinement of searches. An additional image window shows searched images, which are selectable for further search processing, and checkboxes are provided to quickly mark any and all pertinent images with suitability feedback. For example, the image window illustrated in FIG. 3 may contain a set of 16 images, in four rows and four columns. Each of the displayed images is provided with checkboxes 333 and 334 with simplified descriptors such as ‘this search’ 341 and ‘minors’ 343. When the user selects any of these checkboxes and attempts to move on to a next page or previous page by clicking ‘next’ 389 or ‘prev’ 385 buttons the image suitability feedback information is sent to the search server (or sent to the search server on some other reasonable cadence or some other enabling action). In addition, the image window allows the user to select any of the displayed images for further search, or even deselect images from the search that are not meaningful. Such can be performed by dragging and dropping, checkboxes, mouse selections, voice recognition, touch screens, or other mechanisms, as check boxes are not the only way of receiving feedback from a user/machine.

The illustration of FIG. 3 shows a second image being selected and containing checkboxes 333 and 334 with simplified lists/descriptors such as ‘this search’ 341 and ‘minors’ 343. The illustration also shows a search string in the text box 381 as ‘Children Art’ 373, and the selected image as the second one in the first row of displayed images. To initiate a new search, the user may upload a new image to the image window using the upload text box 397 and/or by providing the address of the image in the client device (‘C:/Images/boat.jpg’ 397, in the illustration). The uploaded image appears in the image window once the upload image button 399 is clicked. Also, in the current search, a picture can be selected and marked as “find more images like this” and the server with use correlation processes, quotients, new methods, and other processing to incorporate, into other search results presented to the user, more images like this one selected by the user. A text such as ‘Select Figure for a New Search:’ 393 and ‘Upload New Figure:’ 395 are provided to facilitate initiation of a new image searches or new current search refinements. The user may select or deselect adult content filter button, before clicking on the ‘image search’ button 383. A helpful note, such as ‘Note: This image search engine incorporates Image Suitability Feedback’ may also be provided to the user. The search result page also contains the ‘prev’ 385 and ‘next’ 389 buttons to access prior displayed search result pages and the subsequent search result pages, respectively. By clicking on the title or double clicking on the image, the user may be able watch the corresponding image in its original size in a pop-up window. Further, the functional information, text, graphics, and interfaces shown in FIG. 3 may be combined with other imagery, ads, video, etc. Further, the arrangement and type of the data, buttons, text, etc., in FIG. 3 may be changed and suit the same purpose.

FIG. 4 is an exemplary schematic block diagram illustrating a snap shot of an image search result page containing suitability feedback via a popup window. In specific, the exemplary snap shot illustrated in FIG. 4 shows an image search result page 405 delivered to web browser 435 of the client device, containing selected searched images on the basis of a search string/search image. The illustration also shows a popup window with a title such as ‘Suitability Feedback Window’ 431 with checkboxes 433 through 436 for ‘this search’ 441, ‘minors’ 443, ‘panoramas’ 445, and ‘group photos’ 447 respectively. When the user selects any of these checkboxes and clicks on ‘send’ 451 button the image suitability feedback information is sent to the image search server. It is important to note that many different arrangements and types of suitability information can be collected and used by the system. In some cases, it may desirable or adequate to ask a user to rank images as, very relevant to the search, somewhat relevant, slightly relevant, or not relevant, and default all the selection to one selection that is most likely to occur, like “not relevant”, so there is a default whereby the user does not have to enter in a choice for each image.

The image window illustrated if FIG. 4 may contain a set of 16 images, in four rows and four columns or any number of images in any display format. Some advanced image display formats display images in a three dimensional manner, such as putting images on a rotating cylinder with a dynamic user interface that utilizes the mouse. The image window allows the user to select any of the displayed images for further search processing. The image search result page 405 delivered may contain a page title such as ‘Search Engine's Search Result Page (www.Search_Engine.com)’ 421. A text such as ‘Enter Search String:’ 471 and text box 481 are provided to facilitate new search or refined search parameters, data, key words, etc. The illustration of FIG. 4 also shows a second image being selected. In addition, the illustration shows a search string in the text box 481 as ‘Children Art’ 473, and a selected image as a second image in the first row. To initiate a new search, the user may upload a new image to the image window using the upload text box 497, and/or by providing the address of the image in the client device (‘C:/Images/boat.jpg’, in the illustration). The uploaded image appears in the image window once upload image button 499 is clicked. The user can instruct the server to search for more images that correlate highly to the uploaded image or images, thereby refining a search to more relevant images over time. A text such as ‘Select Figure for a New Search:’ 493 and ‘Upload New Figure:’ 495 are provided to facilitate initiation of a new image search.

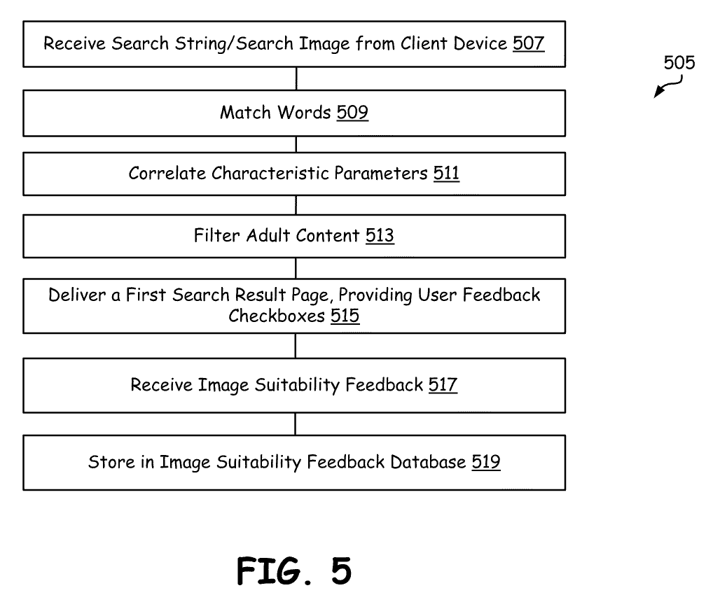

FIG. 5 is a flow diagram illustrating the functionality 505 of the image search server of FIG. 1 during the steps of gathering and storing image suitability feedback information. The image search server functionality begins at a block/step 507, when the image search server receives a search string and/or a search image from the client device. Then, at a next block/step 509, the image search server matches words in the search string with that of titles, meta data, surround text, related text, or like data of a plurality of images in the database and selects images accordingly. The process of selecting images involves word matching between the search string and the titles, etc, of the images available in the database. If a search string is not provided, block/step 509 may be bypassed.

At a next block/step 511, the image search server correlates characteristic parameters of a search image (if provided) with that of the plurality of images in the database and selects images accordingly. The selection process involves creating a table containing image titles and associated web links, prioritized or structured based upon correlation. The image search server then sorts the table on the basis of closeness in correlation. Again, block/step 511 may be bypassed if the user elects only a search string process and does not provide a search image as a reference. Then, at a next block/step 513, the image search server filters selected images to avoid adverse content. In FIG. 4, an example of adverse content is adult images or content, whereby adult content within the images selected using search strings and/or search images is removed, deleted, flagged, obscured, or otherwise rendered safe. At a next block/step 515, the image search server delivers a first search result page containing first few of the selected, sorted, and filtered images using the search string and/or first few selected, sorted and filtered images using the search image. The block/step 515 also provides image suitability feedback checkboxes, pop-up windows, graphical user interfaces (GUIs) or like mechanisms for a user to provide feedback to the search operation. In the first search result page, the image search server provides checkboxes that allows a user to quickly provide feedback that the image is suitable or unsuitable for this search. Also, the checkboxes may be expanded to include a few categories that the image delivered is unsuitable for such as minors, cartoons, panoramas, or other search categories and criteria. In another embodiment, a user mouse click on an ‘Unsuitable For:’ link may open a popup window providing the user options such as (unsuitable for:) ‘this search’, ‘minors’, ‘cartoons’, ‘text images’, ‘panoramas’, etc.

At a next block/step 517, the image search server receives the image suitability feedback from the user of the client device. At a next block/step 519, the image search server stores the image suitability feedback information in an image suitability feedback database and may use that information to refine search results in this search or later searches for this user or other users performing similar searches to seek similar content. In future search operations, the information in the image suitability feedback database is utilized to filter unsuitable images for a search or for a category, or may be used to refine searches to more relevant content for this user or other users.

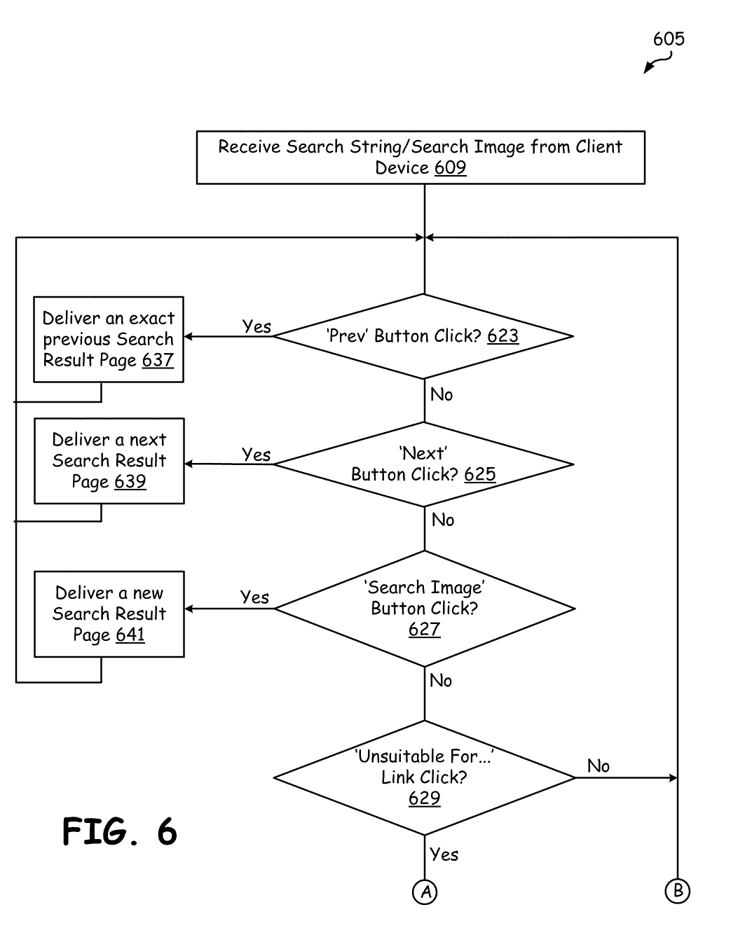

FIG. 6 is a flow diagram illustrating the functionality 605 of the suitability feedback support module of FIG. 1 in conjunction with the operation of the search processes using the image search server. The detailed functionality begins at a block/step 609 where the image search server receives a search string and/or a search image from the client device. At a next decision block/step 623, the image search server verifies if a ‘prev’ (previous) button is clicked. The ‘prev’ button is disabled in a first search result page since there are no previous pages available, and is enabled for subsequent search result pages that have previous pages. If the ‘prev’ button is clicked, at a next block/step 637, the image search server delivers an exact previous search result page and waits for user response. In other embodiments, results presented to a user may be a function of suitability data that may be changing over time as the user selects next and prev operations.

If a ‘prev’ button is not selected at the decision block/step 623, then a next decision block/step 625 is executed and the image search server verifies if a ‘next’ button is clicked. If a ‘next’ button is clicked, at a next block/step 639, the image search server delivers a subsequent search result page to the client/user. If the ‘next’ button is not clicked at the decision block/step 625, then, a next decision block/step 627 is executed and the image search server verifies if a ‘search image’ button is clicked. If a search image button is clicked at the decision block/step 627, then at a next block/step 641 the image search server delivers a new search result page as a consequence of a new search string and/or new or newly-uploaded or revised search image.

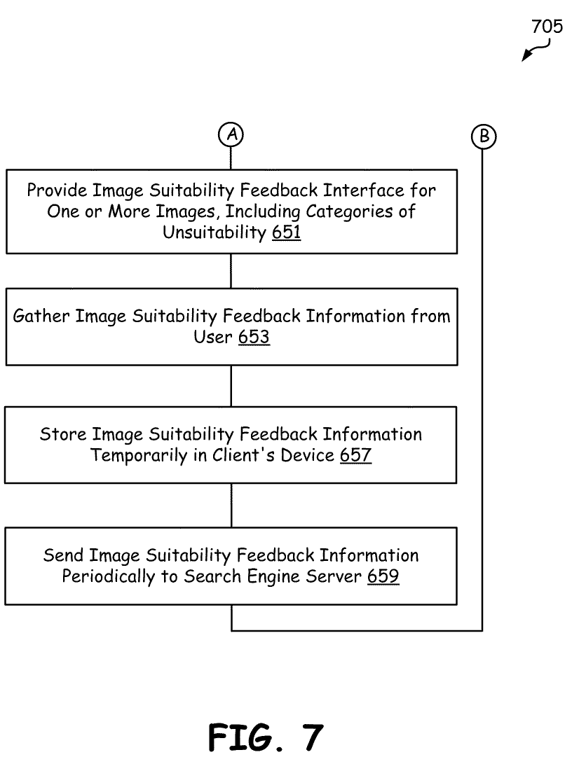

If the search image button is not selected at the decision block/step 627, then at a next decision block/step 629, the image search server verifies if one or more ‘unsuitable for:’ links are clicked. If an ‘unsuitable for:’ link is clicked, the functionality continues with the suitability feedback support module taking over at connector ‘A’ in FIG. 7 (refer to the FIG. 7, for continuation from ‘A’).

FIG. 7 is a continuance of FIG. 6 and completes the flow diagram that illustrates the functionality 705 of the suitability feedback support module of FIG. 1 in conjunction with the image search server. If the unsuitable for button is selected at the decision block 629 (see FIG. 6), the process continues at connector ‘A’ via a next block/step 651. Per step 651, the image search server provides image suitability feedback interface for one or more images, and for one or more search categories. The image suitability feedback interface may be a popup window with a title such as ‘Suitability Feedback Window’ and having many checkboxes for ‘this search’ as well as for many categories such as ‘minors’, ‘panoramas’ and ‘group photos’. When the user selects any of these checkboxes, at a next block 653, the suitability feedback support module gathers this image suitability feedback information from the user, for one or more images.

At a next block/step 657, the suitability feedback support module stores image suitability feedback information temporarily in the client device or some device associated therewith. This temporary storing of information may continue for an entire search operation that includes initiation of a new search, receiving a first search result page, providing image suitability feedback, then continuing onto next pages similarly until the user vacates the image search server site. Storage may also occur for longer durations and span across several user interactions by this one user or many different users. Then, at a next block/step 659, the suitability feedback support module sends image suitability feedback information to the search engine server, either occasionally, periodically, intermittently, continually, or in some other fashion. The period may be seconds, minutes, random, a day, week, month, or just the duration of one entire search operation or a portion thereof.

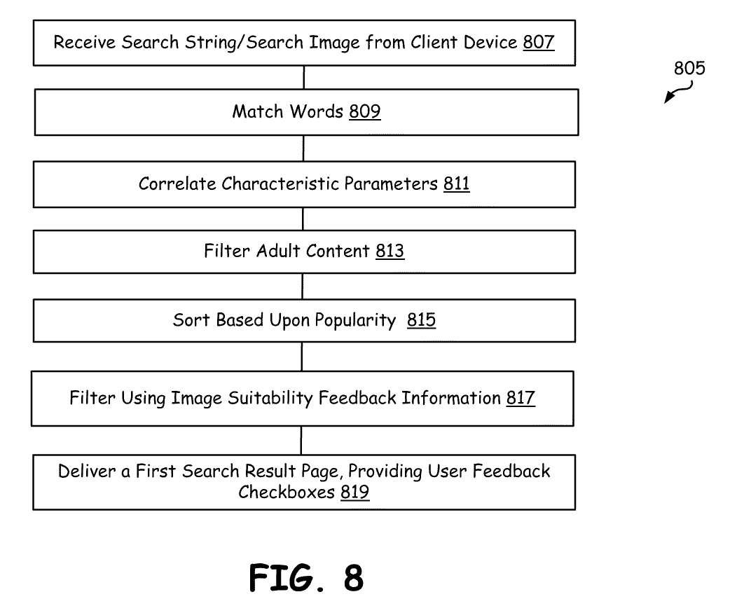

FIG. 8 is a flow diagram illustrating the functionality 805 of the image search server of FIG. 1 during a search operation. The image search server functionality 805 begins at a block/step 807, when the image search server receives a search string and/or a search image from the client device or form a user. At a next block/step 809, the image search server uses word-matching techniques to match words in the search string with that of titles, meta data, surrounding text, text captions, etc., of each of the plurality of images in the image database. The matched images in the image database are given a unique text quotient number that represents the how closely the words of the search string and the words of the titles of the images in the image database match. These text quotient numbers are tabled along with image titles, web links where they are originally located or cached, etc. The images in the image database are obtained from a plurality of web hosting servers by crawling through them and recording the presence of the images, by pier-to-pier interaction, by submission from users, or from other methods that can collect and identify large quantities of image data across many different computers, networks, or sources.

At a next block/step 811, the image search server correlates characteristic parameters of search image with that of the plurality of images in the image database. The correlated images in the image database are given a unique image quotient number that represents the closeness of that image to the exemplary search image. These image quotient numbers are tabled along with other image related aspects such as image titles and web links, where they were originally located. In addition, in another table the first few images (above a threshold image quotient number, for example) that closely correlate with the search image are again sorted on the basis of popularity or via some other criterion or some plurality of criteria.

At a next block/step 813, the image search server filters for adult content (or other unwanted content, like illegal content, violent content, etc) based upon user settings in the client device's web browser. At a next block/step 815, these selected and filtered images are sorted on the basis of correlation/popularity, etc. Then, at a next block/step 817, the image search server retrieves the image suitability feedback information and filters images that are not suited for a given search criteria and/or for a given category. Then, again, the image search server sorts images based upon the image suitability feedback information that is stored in the image suitability feedback information. At a final block/step 819, the image search server delivers a first few of the images selected on the basis of correlation with the characteristic parameters of the search image and/or first few of the images selected on the basis of match with the search string, in a first search result page and any other prev/next search result pages that the user requests. The first search result page (and other next/prev pages) also contains user feedback checkboxes for quick feedback from the user of client device.

The checkboxes provided allow a user to quickly provide feedback that the image is unsuitable for ‘this search’ or for any search of this type in other embodiments. That is, the image can be flagged as unsuitable or not relevant for the current and given search string and search image or for any search correlating highly to this search type or focus. Also, the checkboxes may be expanded to include few categories that the image delivered is unsuitable for such as minors, cartoons, panoramas, this geographic area, a certain work environment, a certain demographic, etc. In another embodiment, a click on an ‘Unsuitable For:’ link may open a popup window providing the user options such as (unsuitable for:) ‘this search’, ‘minors’, ‘cartoons’, ‘text images’, ‘panoramas’, etc.

The terms “circuit” and “circuitry” as used herein may refer to an independent circuit or to a portion of a multifunctional circuit that performs multiple underlying functions. For example, depending on the embodiment, processing circuitry may be implemented as a single chip processor, a multi-core processor, or as a plurality of processing chips. Likewise, a first circuit and a second circuit may be combined in one embodiment into a single circuit or, in another embodiment, operate independently perhaps in separate chips or be segmented into many sub-circuits with finer granularity. The term “chip,” as used herein, refers to an integrated circuit or plurality of integrated circuits packaged in a same package or mounted on a common substrate. Circuits and circuitry may comprise general or specific purpose hardware, or may comprise such hardware and associated software such as firmware, interpreted code, or object code.

As one of ordinary skill in the art will appreciate, the terms “operably coupled” and “communicatively coupled”, as may be used herein, include direct coupling and indirect coupling via another component, element, circuit, or module where, for indirect coupling, the intervening component, element, circuit, or module may or may not modify the information of a signal and may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has also been described above with the aid of method steps illustrating the performance of specified functions and relationships thereof. The boundaries and sequence of these functional building blocks and method steps have been arbitrarily defined herein for convenience of description and may be segmented in a different manner without affecting the spirit and scope of the concepts taught herein. Alternate boundaries and sequences can be defined so long as the specified functions and relationships are appropriately performed. For example, the sequential order of steps/blocks 623, 625, 627, and 629 can easily be changed in FIGS. 6-7 to any order thereof. Any such alternate boundaries or sequences are thus within the scope and spirit of the claimed invention.

The embodiments herein have been described above with the aid of functional building blocks illustrating the performance of certain significant functions/circuits/software. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like, or any combination thereof.

Web browser is used herein to describe the software that performs image searches and displaying. It is important to note that convergence is occurring and new applications are being developed each day that can web browse and or image search/process. Therefore, the web browsers referred to herein may change over time, they may merge with the operating system, they may merge with new application programs like security programs or computer aided design tools, and they may take on added or different functionality over time. The web browsers discussed herein are any programs or hardware/software that search and provide image, multimedia, audio, pictorial, graphic, video, or other content to a client device, server, or user.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

1. A computing device comprising:
a web browser contained in the computing device that support searching of images and displaying of the images;
a first module for providing a search string to a communication interface output of the computing device;
a second module for providing search image data to the communication interface output of the computing device;
a third module for receiving search image search results back from a communication interface input of the computing device, the search image search results correlating to at least one of either the search string or the search image data;
input options within the web browser that allows the computing device to obtain input from at least one user, the input providing image feedback for at least one of the search image search results whereby the image feedback is used to refine image search operations.

2. The computing device of claim 1 wherein the input options are selections made by a user for at least one of the search image search results that instructs the browser if the at least one of the search image search results is desirable for a current user search operation.

3. The computing device of claim 2 wherein the input options and input feedback are used to select images that are better suited for the current user search operation.

4. The computing device of claim 2 wherein the input options and input feedback are used to store information associated with at least one image in the search image search results whereby this information may be used in later searches to provide more meaningful image search results for other search operations.

5. The computing device of claim 2 wherein the input options and input feedback are used to identify images that unsuitable for a current search.

6. The computing device of claim 2 wherein the input options and input feedback are used to identify images that unsuitable for a certain search category performed by any user.

7. The computing device of claim 1 wherein both an image search string and search image data are provided for one search wherein both the search string and the search image data are processed and used to select images to provide to the computing device as the search image search results.

8. The computing device of claim 1 wherein only one of an image search string or search image data are provided for one search wherein just one of the search string or the search image data are processed and used to select images to provide to the computing device as the search image search results.

9. The computing device of claim 1 wherein the search string is text processed and compared to stored text related to images to determine a correlation quotient between the search string and each image, and where the computing device receives, as part of search image search results, those images that correlate well with the search string.

10. The computing device of claim 1 wherein the search string is text processed and compared to a plurality of the following items: file names, URL data, image meta data, and surrounding web text related to images, to determine a correlation quotient between the search string and each image, and where the computing device receives, as part of search image search results, those images that correlate well with the search string.

11. The computing device of claim 1 wherein the search image data is image processed and compared to image data derived from search images to determine a correlation quotient between the search image data and each image that is searched, and wherein the computing device receives, as part of search image search results, those images that correlate well with the search image data.

12. The computing device of claim 1 wherein the user selects one or more search image search results and instructs the web browser to find more images that are similar to the one or more search image search results that were selected.

13. An image search server that supports delivery of images to a plurality of web browsers based upon search criteria, the image search server comprising:
one or more processing units;
memory coupled to the one or more processing units; and
network communication circuitry coupled to the one or more processing units, wherein the one or more processing units, memory, and network communication circuitry are adapted to interoperate to:
receive one or both of an image search string or an exemplary search image via the network communication circuitry to begin an image search operation;
process the image search string, if received for this image search operation, against a plurality of images to create text correlation quotients between the image search string and each of the plurality of images;
process the exemplary search image, if received for this image search operation, against a plurality of images to create image correlation quotients between the image search string and each of the plurality of images;
use one or more of the image correlation quotients or the text correlation quotients to derive image search results from the plurality of images;
process feedback associated with images to further refine which image search results are best suited for a user; and
provide the image search results out through the network communication circuitry for eventual provision to an end user requesting the image search operation.

14. The image search server of claim 13 wherein the image search string is updated during the search and used to provide more refined image search results.

15. The image search server of claim 13 wherein one or more new exemplary search images are selected from the image search results during the search and used to provide more refined image search results.

16. The image search server of claim 13 wherein the feedback is collected for a plurality of images and communicated through the network communication circuitry to the image search server and processed by the image search server to determine which images to provide to improve the relevance of the image search results for the user.

17. The image search server of claim 13 wherein the feedback is collected from the user and communicated through the network communication circuitry to the image search server and processed by the image search server to determine which type of images should not be provided to the user for this image search operation.

18. The image search server of claim 13 wherein the feedback is stored as feedback information and associated with various images so that future searches for this user can use this feedback information to improve image search results.

19. The image search server of claim 13 wherein the feedback is stored as feedback information and associated with various images so that future searches for a plurality of other users can use this feedback information to improve image search results to these other users.

20. A method performed by an image search server that supports delivery of images to a client device containing a web browser, the method comprising:
receiving a search string and a search image from the client device through network interface circuitry to begin a search operation that indicates certain user desires;
matching words in the search string with that of text data associated with images in a database, and using this step of matching to select images that correlate with the user desires;
correlating the search image with that of images in the database, to further select images that correlate with the user desires;
performing adult content filtering, if enabled for this search operation;
sorting selected images based upon a strength of correlation to the user desires;
filtering images from the sorted images using image suitability feedback information provided by the user as search results are provided to the user;
forming a first search result page for presentation to the user that contains user feedback interfaces for the search images and comprises the filtered images as search results; and
delivering the first search result page to the user.
